(19) United States
(12) Patent Application Publication
(10) Pub. No.: US 2023/0063335 A1
(43) Pub. Date: Mar. 2, 2023

(54) DISPLAY APPARATUS, DISPLAY SYSTEM, DISPLAY CONTROL METHOD, AND NON-TRANSITORY RECORDING MEDIUM

(71) Applicant: Yoshihiro Kawashima, Kanagawa (JP)

(72) Inventor: Yoshihiro Kawashima, Kanagawa (JP)

(73) Assignee: Ricoh Company, Ltd., Tokyo (JP)

(21) Appl. No.: 17/818,429

(22) Filed: Aug. 9, 2022

(30) Foreign Application Priority Data
Aug. 27, 2021 (JP) 2021-139274
Jun. 9, 2022 (JP) 2022-093684

(51) Int. Cl. G06F 3/0487; G06F 3/01; G06F 3/038; G06F 3/14

(52) U.S. Cl. CPC G06F 3/0487; G06F 3/017; G06F 3/038; G06F 3/1454

(57) ABSTRACT

A display apparatus includes circuitry to display a display screen based on a video signal input from an information terminal, acquire a change in an image indicating a position on the display screen based on the video signal, and receive an operation with respect to the display screen, based on the change in the image.

### CROSS-REFERENCE TO RELATED APPLICATIONS

This patent application is based on and claims priority pursuant to 35 U.S.C. § 119(a) to Japanese Patent Application Nos. 2021-139274, filed on Aug. 27, 2021, and 2022-093684, filed on Jun. 9, 2022, in the Japan Patent Office, the entire disclosures of which are hereby incorporated by reference.

### BACKGROUND

### Technical Field

Embodiments of the present disclosure relate to a display apparatus, a display system, a display control method, and a non-transitory recording medium.

### Related Art

A known electronic whiteboard has a large-sized display with a touch panel, displays, for example, a display screen displayed on a screen of a personal computer (PC) on the display, and allows a user to write characters or draw figures on the display screen.

In an environment in which wired connection is not suitable, such as a large conference room, a known technique with which a PC and an electronic whiteboard are placed on the same network, remote screen sharing is performed between the PC and the electronic whiteboard, and the electronic whiteboard is operated is usable.

### SUMMARY

According to an aspect of the disclosure includes a display apparatus including circuitry to display a display screen based on a video signal input from an information terminal, acquire a change in an image indicating a position on the display screen based on the video signal, and receive an operation with respect to the display screen, based on the change in the image.

According to an aspect of the disclosure includes a display system including a display apparatus and an information terminal. The display apparatus includes display apparatus circuitry to display a display screen based on a video signal input from an information terminal, acquire a change in an image indicating a position on the display screen based on the video signal, and receive an operation with respect to the display screen, based on the change in the image. The information terminal includes information terminal circuitry to input the video signal to the display apparatus.

According to an aspect of the disclosure includes a display control method including displaying a display screen based on a video signal input from an information terminal, acquiring a change in an image indicating a position on the display screen based on the video signal, and receiving an operation with respect to the display screen, based on the change in the image.

According to an aspect of the disclosure includes a non-transitory recording medium storing a plurality of instructions which, when executed by one or more processors, causes the processors to perform a method. The method includes displaying a display screen based on a video signal input from an information terminal, acquiring a change in an image indicating a position on the display screen based on the video signal, and receiving an operation with respect to the display screen, based on the change in the image.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of a system configuration of a display system according to an exemplary embodiment of the disclosure;

FIG. 2 is a block diagram illustrating an example of a hardware configuration of an electronic whiteboard according to the exemplary embodiment of the disclosure;

FIG. 3 is a block diagram illustrating an example of a hardware configuration of a projector, according to the exemplary embodiment of the disclosure;

FIG. 4 is a block diagram illustrating an example of a hardware configuration of the electronic whiteboard according to the exemplary embodiment of the disclosure;

FIG. 5 is a flowchart illustrating an example of a process of receiving an operation according to a first embodiment of the disclosure;

FIG. 6 is a diagram illustrating for describing a process of detecting a pointer according to the first embodiment of the disclosure;

FIGS. 7A and 7B are diagrams illustrating for describing a process of converting coordinates according to the first embodiment of the disclosure;

FIG. 8 is a diagram illustrating for describing a process of receiving an operation according to the first embodiment of the disclosure;

FIGS. 9A to 9D are diagrams each illustrating an example of a gesture according to the exemplary embodiment of the disclosure;

FIG. 10 is a flowchart illustrating an example of a process of receiving an operation according to a second embodiment of the disclosure; and

FIG. 11 is a flowchart illustrating an example of a process of receiving an operation according to a third embodiment of the disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below of several embodiments of the present disclosure with reference to the attached drawings.

### System Configuration

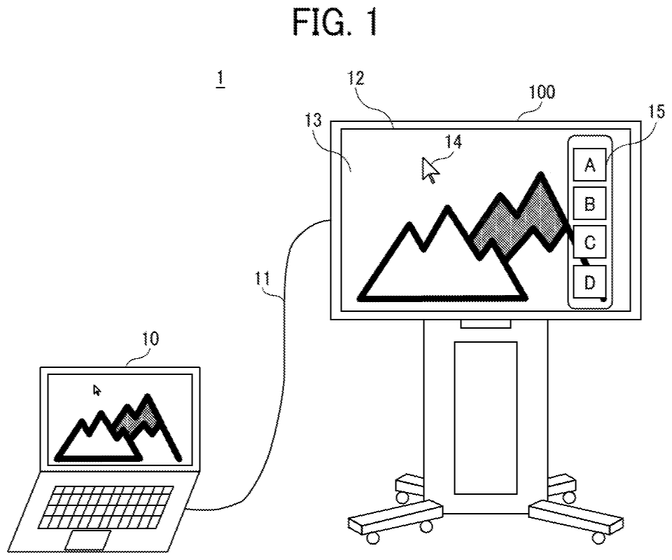

FIG. 1 is a diagram illustrating an example of a system configuration of a display system according to an exemplary embodiment of the disclosure. For example, as illustrated in FIG. 1, a display system 1 includes an information terminal 10 and an electronic whiteboard 100 connected to the information terminal 10 via a video signal cable 11.

The information terminal 10 is, for example, an information processing device such as a personal computer (PC) or a tablet terminal. The video signal cable 11 is a cable for transmitting a digital video signal (wired signal), such as high definition multimedia interface (HDMI) (registered trademark), Display Port, or universal serial bus (USB) Type-C. Further, in the present embodiment, the video signal cable 11 may be a cable for transmitting an analog video signal (wired signal) such as video graphics array (VGA).

The electronic whiteboard 100 is a display equipped with a touch sensor and is also referred to as an interactive white board (IWB). The electronic whiteboard 100 allow a user to directly write on a screen displayed on the display with, for example, a pen or a finger, and store content displayed on the display as data.

The electronic whiteboard 100 may be connected with the information terminal 10 by a video signal cable 11, and display a display screen 13 including a display screen of the information terminal 10 on a display 12 of the electronic whiteboard 100 based on a video signal input from the information terminal 10.

When writing on the display screen 13, an operator (user) stands in front of the electronic whiteboard 100 and operates the electronic whiteboard 100. However, when the electronic whiteboard 100 is used as a large-sized display such as a projector, the operator often sits at a position away from the electronic whiteboard 100. However, with the electronic whiteboard 100, for example, when an operation such as page switching, enlargement/reduction, or screen saving is performed, an operation button 15 on the display screen is operated by the operator being in front of the electronic whiteboard 100.

With a related art, an information terminal and an electronic whiteboard are connected to the same network, and an operator can operate the electronic whiteboard using a remote operation application installed in the information terminal. However, in this method, since the data is transmitted via the network, a drop frame may be displayed or a delay of response to an event including receiving an operation may occur due to occurrence of delay of reproducing a video image, resulting in lack of real-time processing.

To cope with this, the electronic whiteboard 100 according to the present embodiment displays the display screen 13 based on the video signal input from the information terminal 10 via the video signal cable 11, and receives an operation or a setting with respect to the display screen 13 based on the movement of a pointer 14 on the display screen 13.

Accordingly, the electronic whiteboard 100 receives an operation with respect to the display screen 13 while displaying the display screen 13 in real time based on a video signal input from the information terminal 10. In the display apparatus according to the present embodiment (for example the electronic whiteboard 100) that shares a display screen with the information terminal 10 and receives an operation or a setting with respect to the display screen 13 from the information terminal 10, the real-time processing is achievable.

The electronic whiteboard 100 is an example of a display apparatus according to the present embodiment. The electronic whiteboard 100 may be referred to as an electronic whiteboard or an electronic information board, for example. Further, the present embodiment can be suitably applied to various information processing devices. Such an information processing device may be, for example, an output apparatus such as a digital signage, an industrial machine, or a game machine.

In the present embodiment, an operator (user) can operate the electronic whiteboard 100 without using a touch sensor included in the electronic whiteboard 100. Accordingly, the display apparatus according to the present embodiment may be various display apparatuses each having a configuration of a computer, such as a display having no touch sensor or a projector.

### Hardware Configuration

A description is now given below of a hardware configuration of the display apparatus according to the present embodiment.

### Hardware Configuration of Electronic Whiteboard

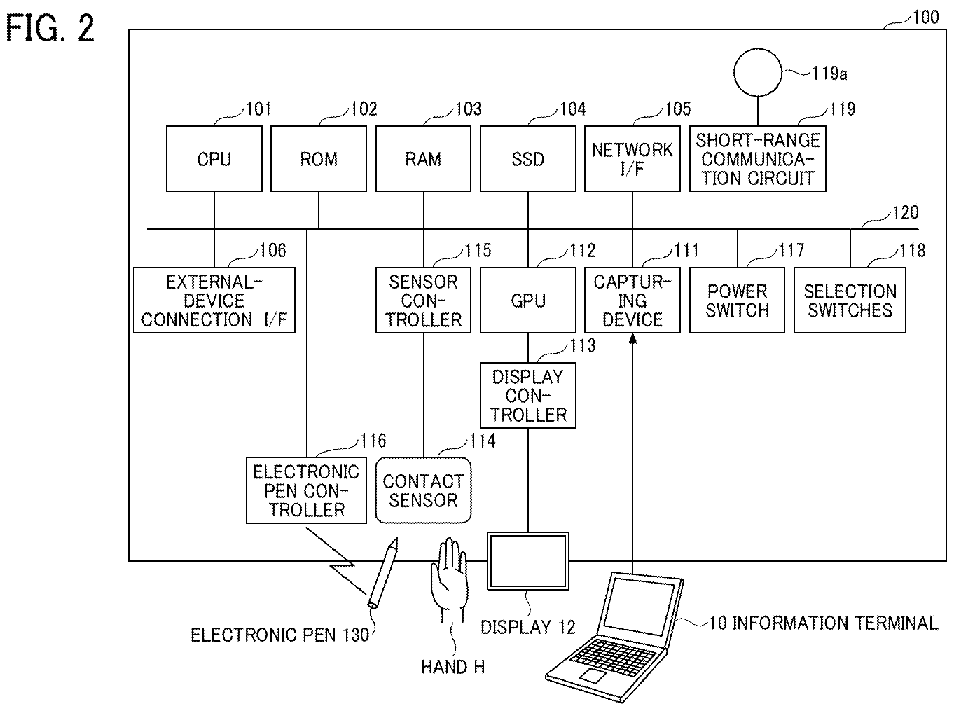

FIG. 2 is a block diagram illustrating an example of a hardware configuration of the electronic whiteboard according to the present embodiment. As illustrated in FIG. 2, the electronic whiteboard 100 includes a central processing unit (CPU) 101, a read only memory (ROM) 102, a random access memory (RAM) 103, a solid state drive (SSD) 104, a network interface (I/F) 105, and an external device connection I/F 106.

The CPU 101 is a processor that controls overall operation of the electronic whiteboard 100. The ROM 102 is a non-volatile memory in which programs such as an initial program loader (IPL) used for booting the CPU 101 are stored. The RAM 103 is a volatile memory used as a work area for the CPU 101. The SSD 104 is a non-volatile large-capacity storage device that stores various types of data such as a program for the electronic whiteboard 100.

The network I/F 105 is a communication interface for connecting the electronic whiteboard 100 to a communication network through which the electronic whiteboard 100 performs communication. The external device connection I/F 106 is an interface that connects to various external devices.

The electronic whiteboard 100 further includes a capturing device 111, a graphics processing unit (GPU) 112, a display controller 113, a contact sensor 114, a sensor controller 115, an electronic pen controller 116, a short-range communication circuit 119, and an antenna 119a for the short-range communication circuit 119, a power switch 117, and selection switches 118.

The capturing device 111 captures (acquires) a display screen displayed on a display of the information terminal 10, which is external to the electronic whiteboard 100, as a still image or a moving image. The GPU 112 is a semiconductor chip (processor) dedicated to processing a graphical image. The display controller 113 controls display of screens to output an image output from the GPU 112 to the display 12, for example. The contact sensor 114 detects a touch onto the display 12 with an electronic pen 130 or a user's hand H. The sensor controller 115 controls the operation of the contact sensor 114.

The contact sensor 114 inputs and senses a coordinate using an infrared blocking system, for example. The inputting and detecting a coordinate may be as follows. For example, two light receiving and emitting devices are disposed at both ends of the upper face of the display 12, and a reflector frame surrounds the periphery of the display 12. The light receiving and emitting devices emit a plurality of infrared rays in parallel to a surface of the display 12. The rays are reflected by the reflector frame, and a light-receiving element receives light returning through the same optical path of the emitted infrared rays. Based on the identifier (ID) of the infrared ray, the sensor controller 115 detects a specific coordinate that is touched by the object. The contact sensor 114 outputs an ID of the infrared ray that is blocked by an object after being emitted from the two light receiving elements, to the sensor controller 115. The electronic pen controller 116 communicates with the electronic pen 130 to detect contact by the tip or bottom of the electronic pen with the display 12. The short-range communication circuit 119 is a communication circuit that performs short-range wireless communication with another device via the antenna 119a.

The power switch 117 is a switch that turns on or off the power of the electronic whiteboard 100. The selection switches 118 are a group of switches for adjusting brightness, hue, etc., of display on the display 12, for example.

The electronic whiteboard 100 further includes a bus line 120. The bus line 120 includes an address bus and a data bus. The bus line 120 electrically connects the hardware components such as the CPU 101 illustrated in FIG. 2 to each other and transmits various control signals.

The contact sensor 114 is not limited to the infrared blocking system type, and may be a different type of detector, such as a capacitance touch panel that identifies a contact position by detecting a change in capacitance, or a resistance film touch panel that identifies a contact position by detecting a change in voltage of two opposed resistance films. In another example, the contact sensor 114 may use an electromagnetic induction touch panel that identifies a contact position by detecting electromagnetic induction caused by contact of an object to the display. In addition or in alternative to detecting a touch by the tip or bottom of the electronic pen 130, the electronic pen controller 116 may also detect a touch by another part of the electronic pen 130, such as a part held by a hand of the user.

### Hardware Configuration of Projector

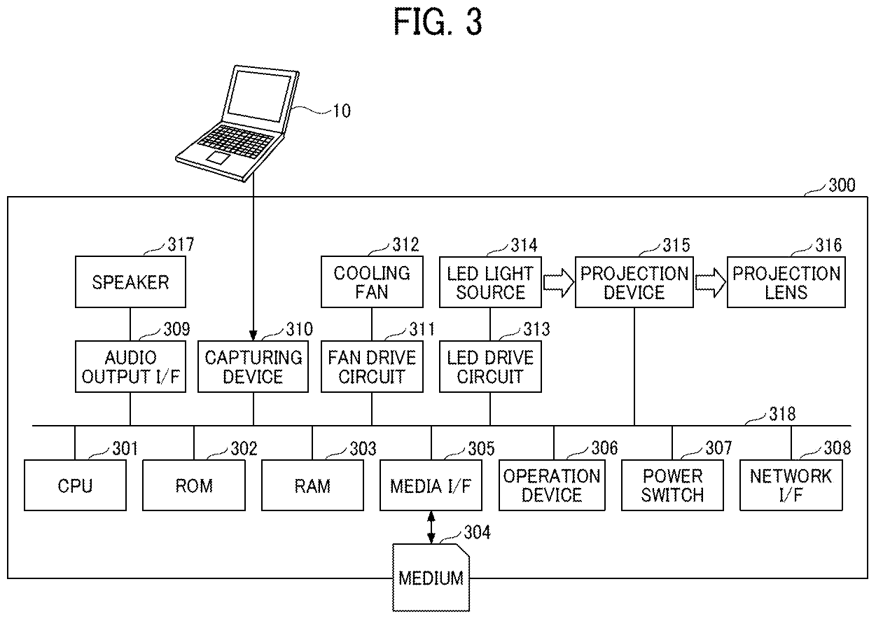

FIG. 3 is a block diagram illustrating an example of a hardware configuration of a projector according to the present embodiment. Note that the projector is an example of a display apparatus having no touch sensor. As illustrated in FIG. 3, the projector 300 includes a CPU 301, a ROM 302, a RAM 303, a media I/F 305, an operation device 306, a power switch 307, a network I/F 308, an audio output I/F 309, a capture device 310, a fan drive circuit 311, a cooling fan 312, and a light emitting diode (LED) drive circuit 313, an LED light source 314, a projection device 315, a projection lens 316, a speaker 317, and a bus line 318.

The CPU 301 performs overall control of the projector 300. The ROM 302 stores a control program for driving the CPU 301. The RAM 303 is used as a work area for the CPU 301. The media I/F 305 controls reading or writing (storing) of data from or to the medium 304, which is an external storage device.

The operation device 306 is provided with various keys, buttons, and LEDs, and is used by a user to perform various operations other than turning on and off the power of the projector 300. For example, the operation device 306 receives an instruction operation such as an operation for adjusting a size of a projected image, an operation for adjusting a color tone, an operation for adjusting a focus, and an operation for adjusting a keystone, and outputs the received operation content to the CPU 301. The power switch 307 is a switch that receives an operation of turning on or off the power of the projector 300.

The network I/F 308 is an interface for connecting the projector 300 to a network, such as a wireless local area network (LAN) or a wired LAN. The audio output I/F 309 is a circuit for outputting audio from the speaker 317 under the control of the CPU 301.

The capture device 310 captures (acquires) a display screen displayed on a display of the information terminal 10, which is external to the electronic whiteboard 100, as a still image or a moving image.

The fan drive circuit 311 is connected to the CPU 301 and the cooling fan 312 and drives or stops the cooling fan 312 based on a control signal from the CPU 301. The cooling fan 312 exhausts the air inside the projector 300 by rotating to cool the inside of the projector 300.

The LED drive circuit 313 turns on and off of the LED light source 314 under the control of the CPU 301. When turned on under the control of the LED drive circuit 313, the LED light source 314 irradiates the projection device 315 with projection light. The projection device 315 transmits modulated light obtained by modulating the projection light from the LED light source 314 by the spatial light modulation method based on image data representing an image to be displayed, through the projection lens 316, whereby an image is projected on a projection surface of the screen. A liquid crystal panel or a digital micromirror device (DMD) is used as the projection device 315, for example. The LED drive circuit 313, the LED light source 314, the projection device 315, and the projection lens 316 function as a projection unit that projects an image on a projection plane based on image data.

The bus line 318 includes an address bus and a data bus. The bus line 318 electrically connects the above components, which are connected to the bus line 318 in FIG. 3, to each other and transmits various control signals.

In the above-described configuration, when the power is supplied, the CPU 301 activates in accordance with a control program, which is stored in the ROM 302 in advance, and supplies a control signal to the LED drive circuit 313 to turn on the LED light source 314. Further, the CPU 301 supplies a control signal to the fan drive circuit 311 to rotate the cooling fan 312 at a predetermined rated speed. Further, when the power supply is started, the projection device 315 enters an image displayable state, and the power is supplied to various other components in the projector 300.

When the power switch 307 of the projector 300 is turned off, a power-off signal is transmitted from the power switch 307 to the CPU 301. When detecting the power-off signal, the CPU 301 supplies a control signal to the LED drive circuit 313 to turn off the LED light source 314. Then the CPU 301 transmits a control signal to the fan drive circuit 311 to stop the cooling fan 312, terminates its own control processing, and finally transmits an instruction to the power supply circuit to stop the power supply.

### Functional Configuration

### Functional Configuration of Electronic Whiteboard

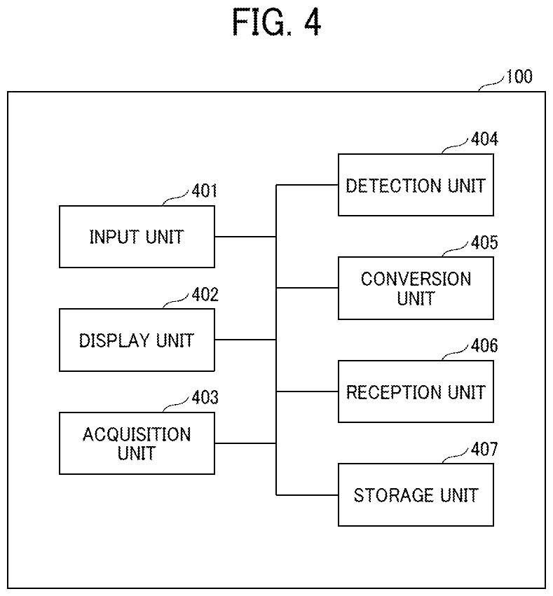

FIG. 4 is a block diagram illustrating an example of a hardware configuration of the electronic whiteboard 100 according to the present embodiment. The electronic whiteboard 100, which is an example of display apparatus, includes, for example, an input unit 401, a display unit 402, an acquisition unit 403, a detection unit 404, a conversion unit 405, a reception unit 406, and a storage unit 407 each of which is implemented by the CPU 101 executing one or more programs stored in a recording medium such as the SSD 104. At least a part of the above-described functional units may be implemented by hardware.

The input unit 401 executes an input process of receiving an input of a video signal from the information terminal 10.

For example, the input unit 401 captures a video signal input from the information terminal 10 by using the capture device 111.

The display unit 402 executes display processing for displaying a display screen based on a video signal input from the information terminal 10 to the input unit 401. For example, as illustrated in FIG. 1, the display unit 402 displays, on the display 12 of the electronic whiteboard 100, the display screen 13 including a screen being displayed on the information terminal 10 and the operation buttons 15. The operation button 15 is an example of a display component that receives an operation with respect to the display screen 13 or the electronic whiteboard 100.

The acquisition unit 403 acquires a change in an image on the display screen 13 based on the video signal input to the input unit 401. For example, the acquisition unit 403 acquires a trajectory of the pointer 14, such as a mouse pointer of the information terminal 10, indicating a position on the display screen 13. The trajectory of a pointer is an example of a change in an image indicating a position on the display screen 13.

The detection unit 404 executes a detection process for detecting a predetermined gesture based on the trajectory of the pointer 14 acquired by the acquisition unit 403. For example, the detection unit 404 detects a predetermined gesture representing an operation such as “selecting”, “cancelling”, or “returning” based on the trajectory of the pointer 14.

The conversion unit 405 executes a conversion process for converting coordinates of the trajectory of the gesture detected by the detection unit 404 to coordinates on the electronic whiteboard 100. The detection unit 404 or the conversion unit 405 may be included in the reception unit 406.

The reception unit 406 executes receiving processing of receiving an operation with respect to the display screen 13 based on the trajectory of the pointer acquired by the acquisition unit 403. For example, when the gesture detected by the detection unit 404 represents the “selecting” operation, the reception unit 406 specifies the selected operation button 15 from the coordinates of the trajectory of the gesture converted into the coordinates on the electronic whiteboard 100 by the conversion unit 405, and receives the selecting operation of selecting the specified operation button 15.

As another example, in a case where the gesture detected by the detection unit 404 indicates a “cancelling” operation, the reception unit 406 receives a cancelling operation of canceling a previous operation performed immediately before. In this case, the conversion unit 405 may or may not perform the conversion process of converting the coordinates of the trajectory of the gesture to the coordinates on the electronic whiteboard 100.

The storage unit 407 is implemented by, for example, a program executed by the CPU 101 and a memory such as the RAM 103 or the SSD 104, and stores various information such as coordinates of a pointer or information on a predetermined gesture.

### Functional Configuration of Projector

The projector 300 implements a functional configuration similar to the functional configuration of the electronic whiteboard 100 illustrated in FIG. 4 by the CPU 301 executing one or more programs stored in a recording medium such as the ROM 302 or the medium 304, for example. Since each functional unit of the projector 300 is similar to each corresponding functional unit of the electronic whiteboard 100, description thereof will be omitted.

### Process

A description is given below of a processing flow of a display control method according to the first embodiment of the disclosure.

### Receiving of Operation

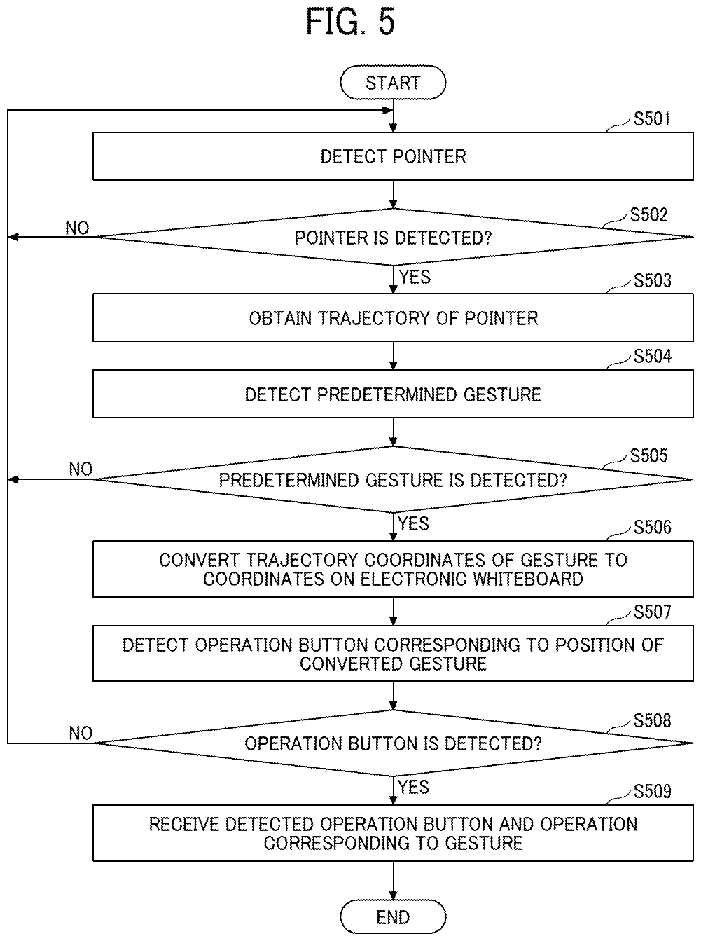

FIG. 5 is a flowchart illustrating an example of a process of receiving an operation according to a first embodiment of the disclosure. The process is an example of receiving processing in which the electronic whiteboard 100 receives an operation performed with respect to the operation button 15 displayed on the display screen 13 of the electronic whiteboard 100 by the operator (user) who operates the information terminal 10 using, for example, a mouse pointer in the display system 1 illustrated in FIG. 1.

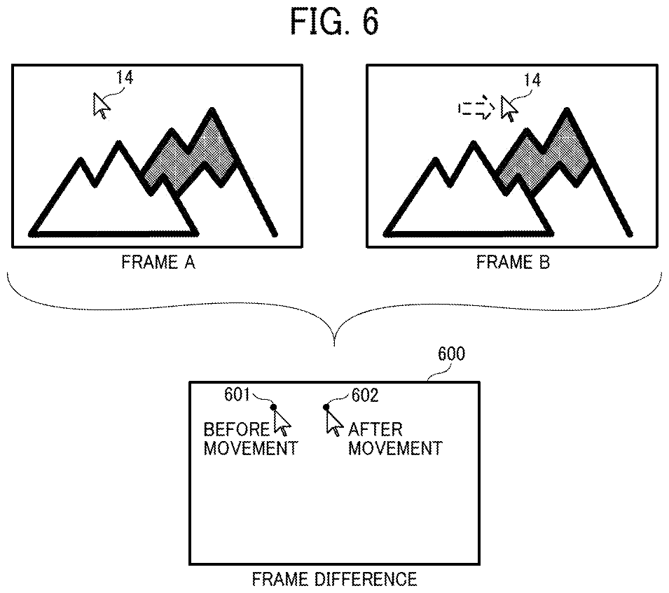

In step S501, the acquisition unit 403 of the electronic whiteboard 100 detects the pointer 14 indicating a position on the display screen 13 from a video signal input to the input unit 401. For example, as illustrated in FIG. 6, the acquisition unit 403 calculates a luminance difference between a frame A and a frame B that is a frame next to the frame A, and binarizes the luminance difference using a threshold value. As a result, for example, as illustrated in a frame difference 600 in FIG. 6, coordinates 601 and coordinates 602 of the pointer 14, respectively, before and after the movement are acquired. Note that the method of detecting the pointer 14 is not limited thereto, and any detection method may be used.

In step S502, when the pointer 14 is detected, the process proceeds to step S503, namely the processing of the acquisition unit 403 in step S502 is shifted step S503. On the other hand, when the pointer 14 is not detected, the process returns to step S501, namely the processing of the acquisition unit 403 is shifted to step 501.

In step S503, the acquisition unit 403 acquires a trajectory of the detected pointer 14. For example, the acquisition unit 403 acquires the coordinates of the detected pointer 14 and sequentially stores the acquired coordinates in the storage unit 407 for a predetermined period, thereby acquiring the trajectory of the coordinates of the pointer 14.

In step S504, the detection unit 404 of the electronic whiteboard 100 detects a predetermined gesture based on the trajectory of the pointer 14 acquired by the acquisition unit 403. As an example, the detection unit 404 may store trajectory information of a plurality of predetermined gestures in the storage unit 407, obtain a difference between the stored trajectory information and the trajectory of the pointer 14 acquired by the acquisition unit 403, and detect a gesture having the smallest sum of all pixel values. In addition, as another example, the detection unit 404 may learn a gesture action of a user in advance by machine learning, and may detect a gesture by reading the trajectory of the pointer 14 acquired by the acquisition unit 403.

Alternatively, the detection unit 404 may store feature amounts extracted from a plurality of predetermined gestures in the storage unit 407 in advance, calculate a degree of similarity with a feature amount extracted from the trajectory of the pointer 14 acquired by the acquisition unit 403, and detect a gesture in which the degree of similarity is equal to or greater than a threshold value.

In step S505, when the predetermined gesture is detected, the process proceeds to step S506, namely the processing of the detection unit 404 in step S505 is shifted to step S506. On the other hand, when the predetermined gesture is not detected, the process returns to step S501, namely the processing of the detection unit 404 is shifted to step 501.

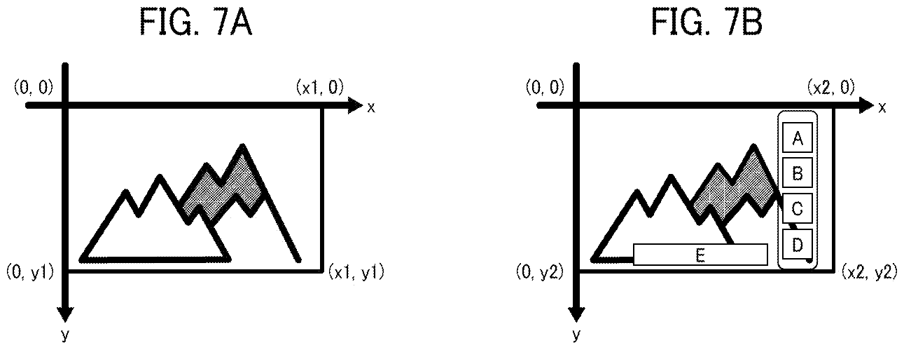

In step S506, the conversion unit 405 of the electronic whiteboard 100 converts the coordinates of the trajectory of the gesture detected by the detection unit 404 into coordinates on the electronic whiteboard 100. For example, as illustrated in FIGS. 7A and 7B, when a coordinate space of the information terminal 10 and a coordinate space of the electronic whiteboard 100 are different from each other, the conversion unit 405 converts the trajectory of the pointer 14 in the coordinate space of the information terminal 10 into the trajectory in the coordinate space of the electronic whiteboard 100. At this time, the conversion unit 405 may convert the entire trajectory of the pointer 14. Alternatively, the conversion unit 405 may convert the center coordinates of the gesture since the gesture has already been determined.

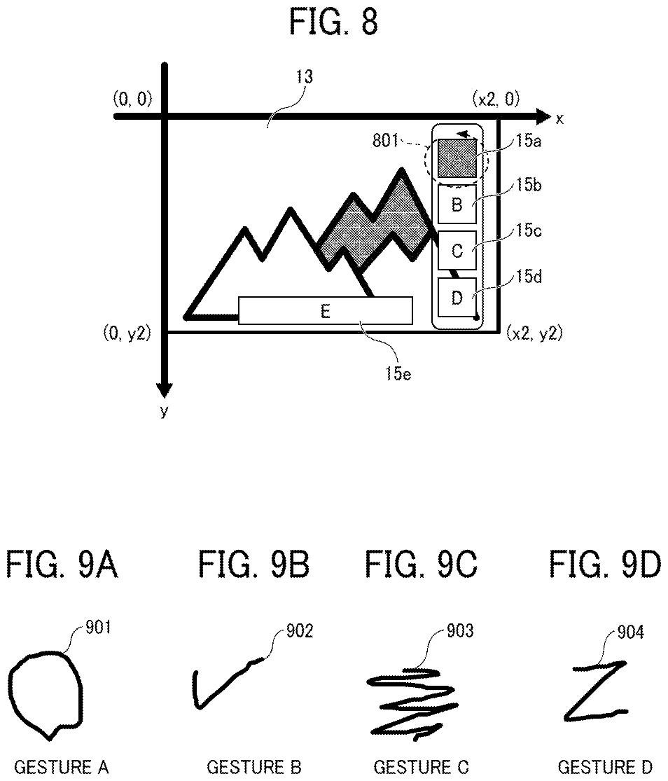

In step S507, the reception unit 406 of the electronic whiteboard 100 detects the operation button 15 corresponding to a position of the gesture converted by the conversion unit 405. For example, it is assumed that the display unit 402 displays a plurality of operation buttons 15a to 15e on the display screen 13 as illustrated in FIG. 8, and there is a converted gesture 801 around the operation button 15a. In this case, the reception unit 406 detects the operation button 15a corresponding to the gesture 801 (surrounded by the gesture 801).

Alternatively, the reception unit 406 may detect the operation button 15a within a predetermined range from the center coordinates of the gesture 801 as the operation button 15 corresponding to the gesture 801.

In step S508, when the operation button is detected, the process proceeds to step S509, namely the processing of the reception unit 406 in step S508 is shifted to step S509.

On the other hand, when the operation button is not detected, the process returns to step S501, namely the processing of reception unit 406 is shifted to step 501.

In step S509, the detected operation button 15 and an operation corresponding to the gesture is received. FIGS. 9A to 9D is a diagram each illustrating an example of a gesture according to the present embodiment. For example, the reception unit 406 may receive a gesture of surrounding the detected operation button 15 with a circle like a gesture A 901 of FIG. 9A as a selecting operation of selecting the operation button 15.

As another example, the reception unit 406 may receive a gesture of checking the detected operation button 15 like a gesture B 902 of FIG. 9B as a selecting operation of selecting the detected operation button 15. Alternatively, the reception unit 406 may receive a gesture of checking the detected operation button 15 like a gesture B 902 of FIG. 9B as a cancelling operation of cancelling a selection of the operation button 15.

As still another example, the reception unit 406 may receive a gesture of moving the pointer 14 to the left or right a predetermined number of times or more on the detected operation button 15, as in a gesture C 903 of FIG. 9C, as a canceling operation of canceling a selection of the operation button 15. Each operation described above is an example, and the gesture received by the reception unit 406 may be an arbitrary gesture.

Through the process of receiving an operation illustrated in FIG. 5, the electronic whiteboard 100 receives an operation with respect to the display screen 13 based on the movement of the pointer 14 on the display screen 13 while displaying the display screen 13 based on the video signal input from the information terminal 10.

Note that the display unit 402 of the electronic whiteboard 100 may display the operation button 15 for receiving an operation or a setting with respect to the display screen 13 for such as page switching, scaling, and screen saving, and the reception unit 406 may receive an operation performed by the operator (user) on the display screen 13. The display unit 402 of the electronic whiteboard 100 may display the operation button 15 for receiving an operation or a setting with respect to the electronic whiteboard 100 for such as one related to luminance, contrast, aspect, volume, or a power saving function, and the reception unit 406 may receive an operation performed by the operator (user) with respect to the electronic whiteboard 100.

Although the electronic whiteboard 100 is used as an example of display apparatus to perform the process illustrated in FIG. 5, since the process in FIG. 5 does not use a touch sensor, the same process can be applied to a display apparatus that does not include a touch sensor, such as the projector 300.

### Second Embodiment

In the first embodiment, the reception unit 406 of the electronic whiteboard 100 receives the operation corresponding to the operation button 15 and the operation corresponding to the gesture, but this is not limiting. The reception unit 406 may further receive a specific operation corresponding to a gesture that does not depend on the operation button 15.

For example, the reception unit 406 may receive a gesture of moving the pointer 14 to the left or right a predetermined number of times or more in an arbitrary area on the display screen 13 as a gesture C 903 of FIG. 9C, as a cancel operation of canceling an operation performed immediately before. As another example, the reception unit 406 may receive a gesture of drawing a “Z”-shape as a gesture D 904 of FIG. 9D in an arbitrary area as an operation of returning to a screen displayed immediately before or a state before a current operation is performed.

### Process

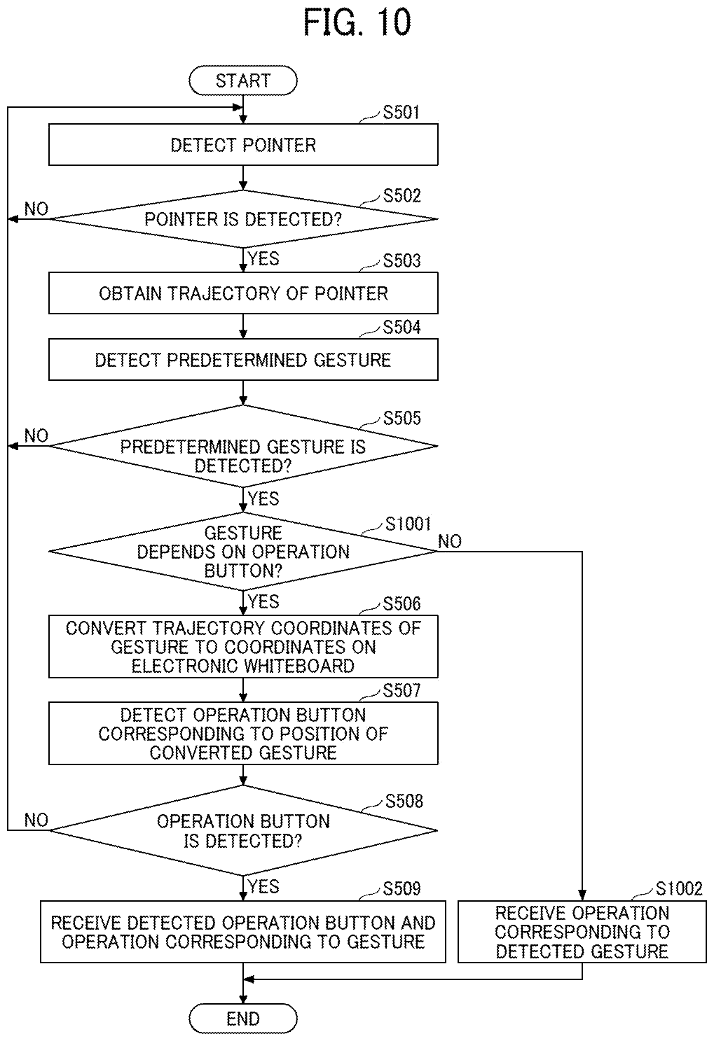

FIG. 10 is a flowchart illustrating an example of a process of receiving an operation according to the second embodiment of the disclosure. The process is another example of receiving processing in which the electronic whiteboard 100 receives an operation performed with respect to the operation button 15 displayed on the display screen 13 of the electronic whiteboard 100 by the operator (user) who operates the information terminal 10 using, for example, a mouse pointer in the display system 1 illustrated in FIG. 1.

Among the steps illustrated in FIG. 10, the processing of steps S501 to S504 and the processing of steps S506 to S509 are substantially the same as the processing of the steps of the same step numerals in FIG. 5. Accordingly, the following description focuses on differences from the first embodiment. The functional configuration of the electronic whiteboard 100 according to the second embodiment is substantially the same as that of the electronic whiteboard 100 according to the first embodiment illustrated in FIG. 4.

In step S505 of FIG. 10, when the predetermined gesture is detected, the process performed by electronic whiteboard 100 proceeds to step S1001, namely the processing of the detection unit 404 performed in step S505 is shifted to step S1001.

In step S1001, the reception unit 406 of the electronic whiteboard 100 determines whether the gesture detected by the detection unit 404 is a gesture depending on the operation button 15.

For example, the reception unit 406 may determine whether the detected gesture depends on the operation button 15 by classifying predetermined gestures into a gesture depending on the operation button 15 and a gesture that does not depend on the operation button 15 and storing the gestures in the storage unit 407 in advance.

When the detected gesture is a gesture depending on the operation button 15, the process proceeds to step S506, namely the processing of the reception unit 406 performed in step S1001 is shifted to step S506. On the other hand, in a case where the detected gesture is a gesture that does not depend on the operation button 15, the process proceeds to step S1002, namely the processing of the reception unit 406 performed in step S1001 is shifted to step S1002.

When the process proceeds to step S1002, the reception unit 406 receives a specific operation corresponding to the detected gesture. For example, the reception unit 406 may receive a gesture of moving the pointer 14 to the left or right a predetermined number of times or more in an arbitrary area on the display screen 13 as a gesture C 903 of FIG. 9C, as a cancel operation of canceling an operation performed immediately before.

As another example, the reception unit 406 may receive a gesture of drawing a “Z”-shape as a gesture D 904 of FIG. 9D in an arbitrary area as an operation of returning to a screen displayed immediately before or a state before a current operation is performed. Each gesture described above is an example, and the gesture received by the reception unit 406 may be an arbitrary gesture.

Through the process of receiving an operation illustrated in FIG. 10, the electronic whiteboard 100 receives an operation with respect to the display screen 13 based on the movement of the pointer 14 on the display screen 13 while displaying the display screen 13 based on the video signal input from the information terminal 10.

The electronic whiteboard 100 is used as an example of display apparatus to perform the process illustrated in FIG. 10, since the process in FIG. 10 does not use a touch sensor, the same process can be applied to a display apparatus that does not include a touch sensor, such as the projector 300.

### Third Embodiment

In the second embodiment, the reception unit 406 of the electronic whiteboard 100 receives a gesture depending on the operation button 15 and a gesture that does not depend on the operation button 15, but this is not limiting. The reception unit 406 may receive an operation that does not depend on the operation button 15 without an operation depending on the operation button 15.

### Functional Configuration

As an example, the electronic whiteboard 100 according to the third embodiment has substantially the same functional configuration as the electronic whiteboard 100 according to the first embodiment described with reference to FIG. 4. As another example, the electronic whiteboard 100 according to the third embodiment may have a functional configuration in which the detection unit 404 and the conversion unit 405 are omitted from the functional configuration of the electronic whiteboard 100 according to the first embodiment described with reference to FIG. 4.

### Process

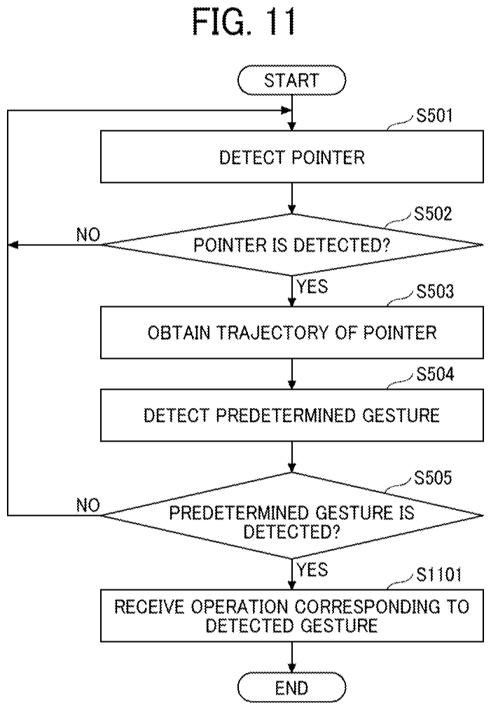

FIG. 11 is a flowchart illustrating an example of a process of receiving an operation according to a third embodiment of the disclosure. The process is another example of receiving processing in which the electronic whiteboard 100 receives an operation performed with respect to the operation button 15 displayed on the display screen 13 of the electronic whiteboard 100 by the operator (user) who operates the information terminal 10 using, for example, a mouse pointer in the display system 1 illustrated in FIG. 1. Among the steps illustrated in FIG. 11, the processing of steps S501 to S504 are substantially the same as the processing of the steps of the same step numerals in FIG. 5. Accordingly, the following description focuses on differences from the first embodiment.

In step S505 of FIG. 11, when the predetermined gesture is detected, the process performed by electronic whiteboard 100 proceeds to step S1101, namely the processing of the detection unit 404 performed in step S505 is shifted to step S1101.

When the process proceeds to step S1101, the reception unit 406 receives a specific operation corresponding to the detected gesture. For example, the reception unit 406 may receive a gesture of moving the pointer 14 to the left or right a predetermined number of times or more in an arbitrary area on the display screen 13 as a gesture C 903 of FIG. 9C, as a cancel operation of canceling an operation performed immediately before.

As another example, the reception unit 406 may receive a gesture of drawing a “Z”-shape as a gesture D 904 of FIG. 9D in an arbitrary area as an operation of returning to a screen displayed immediately before or a state before a current operation is performed. The gesture described above is an example, and the gesture received by the reception unit 406 may be an arbitrary gesture.

Through the process of receiving an operation illustrated in FIG. 11, the electronic whiteboard 100 receives an operation with respect to the display screen 13 based on the movement of the pointer 14 on the display screen 13 while displaying the display screen 13 based on the video signal input from the information terminal 10.

The electronic whiteboard 100 is used as an example of display apparatus to perform the process illustrated in FIG. 11, since the process in FIG. 11 does not use a touch sensor, the same process can be applied to a display apparatus that does not include a touch sensor, such as the projector 300.

Accordingly, the electronic whiteboard according to each embodiment described above of the present disclosure can receive an operation or a setting with respect to the display screen 13 while displaying the display screen 13 in real time based on a video signal input from the information terminal 10. In the display apparatus according to the above-described embodiment (for example, the electronic whiteboard 100 or the projector 300) that shares a display screen with the information terminal 10 and receives an operation with respect to the display screen 13 from the information terminal 10, the real-time processing is achievable.

Each of the functions of the described embodiments can be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

Aspects of the present disclosure relate to a display apparatus, a display control method, and a recording medium.

### First Aspect

According to a first aspect of the present disclosure, a display apparatus includes a display unit to display a display screen based on a video signal input from an information terminal, an acquisition unit to acquire a change in an image indicating a position on the display screen based on the video signal, and a reception unit to receive an operation with respect to the display screen, based on the change in the image.

### Second Aspect

According to a second aspect of the present disclosure, in the display apparatus according to the above-described first aspect, the display unit displays, on the display screen, a display component to receive an operation or a setting with respect to the display screen.

### Third Aspect

According to a third aspect of the present disclosure, in the display apparatus according to the above-described first aspect, the display unit displays, on the display screen, a display component to receive an operation or a setting with respect to the display apparatus.

### Fourth Aspect

According to a fourth aspect of the present disclosure, in the display apparatus according to any one of the above-described second aspect and the above-described third aspect, the reception unit receives an operation with respect to the display component according to the change in the image corresponding to the position of the display component.

### Fifth Aspect

According to a fifth aspect of the present disclosure, in the display apparatus according to any one of the above-described first aspect to the above-described fourth aspect, in case that the change in the image indicates a predetermined gesture, the reception unit receives a specific operation corresponding to the gesture.

### Sixth Aspect

According to a sixth aspect of the present disclosure, in the display apparatus according to the above-described fifth aspect, the gesture includes a gesture corresponding to one or more operations of selecting, cancelling, and returning.

### Seventh Aspect

According to a seventh aspect of the present disclosure, in the display apparatus according to any one of the above-described first aspect to the above-described fourth aspect, the video signal includes a wired signal that is one of a digital signal and an analog signal.

### Eighth Aspect

According to an eighth aspect of the present disclosure, in the display apparatus according to any one of the above-described first aspect to the above-described seventh aspect, the change in the image includes a trajectory of a pointer indicating the position on the display screen.

### Nineth Aspect

According to a nineth aspect of the present disclosure, a display system includes a display unit to display a display screen based on a video signal input from an information terminal, an acquisition unit to acquire a change in an image indicating a position on the display screen based on the video signal, and a reception unit to receive an operation with respect to the display screen, based on the change in the image.

### Tenth Aspect

According to a nineth aspect of the present disclosure, a display control method includes displaying a display screen based on a video signal input from an information terminal, acquiring a change in an image indicating a position on the display screen based on the video signal, and receiving an operation with respect to the display screen, based on the change in the image.

### Eleventh Aspect

According to an eleventh aspect of the present disclosure, a program causes a computer to execute the display control method according to the above-described tenth aspect.

### Twelfth Aspect

According to a nineth aspect of the present disclosure, a display apparatus includes a display unit to display a display screen based on a video signal input from an information terminal, an acquisition unit to acquire a trajectory of a pointer indicating a position on the display screen based on the video signal, and a reception unit to receive an operation with respect to the display screen based on the trajectory of the pointer.

### Thirteenth Aspect

According to a thirteenth aspect of the present disclosure, in the display apparatus according to the above-described twelfth aspect, the display unit displays, on the display screen, a display component to receive an operation or a setting with respect to the display screen.

### Fourteenth Aspect

According to a fourteenth aspect of the present disclosure, in the display apparatus according to the above-described twelfth aspect, the display unit displays, on the display screen, a display component to receive an operation or a setting with respect to the display apparatus.

### Fifteenth Aspect

According to a fourteenth aspect of the present disclosure, in the display apparatus according to any one of the above-described thirteenth aspect and the above-described fourteenth aspect, the reception unit receives an operation with respect to the display component according to the trajectory of the pointer corresponding to the position on the display component.

### Sixteenth Aspect

According to a sixteenth aspect of the present disclosure, in the display apparatus according to any one of the above-described twelfth aspect to the above-described fifteenth aspect, in case that the trajectory of the pointer indicates a predetermined gesture, the reception unit receives a specific operation corresponding to the gesture.

### Seventeenth Aspect

According to a seventeenth aspect of the present disclosure, in the display apparatus according to the above-described sixteenth aspect, the gesture includes a gesture corresponding to one or more operations of selecting, cancelling, and returning.

### Eighteenth Aspect

According to an eighteenth aspect of the present disclosure, in the display apparatus according to any one of the above-described twelfth aspect to the above-described fifth aspect, the video signal includes a wired signal that is one of a digital signal and an analog signal.

### Nineteenth Aspect

According to a nineth aspect of the present disclosure, a display apparatus includes a display unit to display a display screen based on a video signal input from an information terminal, an acquisition unit to acquire a trajectory of a pointer indicating a position on the display screen based on the video signal, and a reception unit to receive an operation with respect to the display screen, based on the trajectory of the pointer.

### Twentieth Aspect

According to a twentieth aspect of the present disclosure, a display control method includes displaying a display screen based on a video signal input from an information terminal, acquiring a trajectory of a pointer indicating a position on the display screen based on the video signal, and receiving an operation with respect to the display screen based on the trajectory of the pointer.

### Twenty-first Aspect

According to a twenty-first aspect of the present disclosure, a program causes a computer to execute the display control method according to the above-described twentieth aspect.

The above-described embodiments and aspects are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

With a related technique, since screen sharing, via a network, between an information processing device such as a PC and an electronic whiteboard may not be performed in real time. This may occur in cases of using any of various types of display apparatuses that share a display screen with an information processing device and receive an operation or a setting with respect to the display screen, in addition to the electronic whiteboard.

According to an embodiment of the present disclosure, a display apparatus that shares a display screen with an information terminal achieves to receive an operation or a setting with respect to the display screen from the information terminal in real time.

The present disclosure can be implemented in any convenient form, for example using dedicated hardware, or a mixture of dedicated hardware and software. The present disclosure may be implemented as computer software implemented by one or more networked processing apparatuses. The network can include any conventional terrestrial or wireless communications network, such as the Internet. The processing apparatuses can include any suitably programmed apparatus such as a general purpose computer, personal digital assistant, mobile telephone (such as a wireless application protocol (WAP) or 3G-compliant phone), for example. Since the present disclosure can be implemented as software, each or every aspect of the present disclosure thus encompasses computer software implementable on a programmable device. The computer software can be provided to the programmable device using any storage medium for storing processor readable code such as a floppy disk, hard disk, CD ROM, magnetic tape device or solid state memory device.

The hardware platform includes any desired kind of hardware resources including, for example, a CPU, an RAM, and a hard disk drive (HDD). The CPU may be implemented by any desired kind of any desired number of processors. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

1. A display apparatus, comprising circuitry configured to:
display a display screen based on a video signal input from an information terminal;
acquire a change in an image indicating a position on the display screen based on the video signal; and
receive an operation with respect to the display screen, based on the change in the image.

2. The display apparatus of claim 1, wherein
the circuitry displays, on the display screen, a display component to receive at least one of an operation or a setting with respect to the display screen.

3. The display apparatus of claim 1, wherein
the circuitry displays, on the display screen, a display component to receive at least one of an operation or a setting with respect to the display apparatus.

4. The display apparatus of claim 2, wherein
the circuitry receives the operation with respect to the display component according to the change in the image corresponding to a position of the display component.

5. The display apparatus of claim 1, wherein
in case that the change in the image indicates a predetermined gesture, the circuitry receives the operation indicating a specific operation corresponding to the gesture.

6. The display apparatus of claim 5, wherein
the gesture includes a gesture corresponding to one or more of a selecting operation, a cancelling operation, and a returning operation.

7. The display apparatus of claim 5, wherein
the video signal includes a wired signal that is one of a digital signal and an analog signal.

8. The display apparatus of claim 1, wherein
the change in the image includes a trajectory of a pointer indicating the position on the display screen.

9. A display system, comprising:
the display apparatus of claim 1; and
the information terminal including information terminal circuitry configured to input the video signal to the display apparatus.

10. A display control method, comprising:
displaying a display screen based on a video signal input from an information terminal;
acquiring a change in an image indicating a position on the display screen based on the video signal; and
receiving an operation with respect to the display screen, based on the change in the image.

11. A non-transitory recording medium storing a plurality of instructions which, when executed by one or more processors, causes the processors to perform a method, the method comprising:
displaying a display screen based on a video signal input from an information terminal;
acquiring a change in an image indicating a position on the display screen based on the video signal; and
receiving an operation with respect to the display screen, based on the change in the image.
